(19) United States
(12) Patent Application Publication
(10) Pub. No.: US 2014/0191679 A1
(43) Pub. Date: Jul. 10, 2014

(54) DIMMING CIRCUIT AND LIGHTING DEVICE USING THE SAME

(71) Applicant: Lextar Electronics Corporation, Hsinchu (TW)

(72) Inventors: Chun-Kuang Chen, Taipei City (TW); Po-Shen Chen, New Taipei City (TW); Feng-Ling Lin, Pingtung City (TW); Hui-Ying Chen, Changhua County (TW)

(73) Assignee: Lextar Electronics Corporation, Hsinchu (TW)

(21) Appl. No.: 14/089,800

(22) Filed: Nov. 26, 2013

(30) Foreign Application Priority Data
Jan. 7, 2013 (TW) 102100372

(51) Int. Cl. H05B 33/08

(52) U.S. Cl. CPC H05B 33/0809
USPC 315/200 R; 315/287

(57) ABSTRACT

A dimming circuit and a lighting device using the same are provided. The dimming circuit comprises an interface trigger unit, an average duty cycle calculating unit, a control voltage calculating unit and a comparing unit. The interface trigger unit receives an on-time of each pulse width from each period in a PWM signal. The average duty cycle calculating unit is coupled to the interface trigger unit and calculates a ratio of the on-time to the period. The control voltage calculating unit is coupled to the average duty cycle calculating unit, and calculates a desired voltage according to the ratio. The comparing unit is coupled to the control voltage calculating unit, and sends the desired voltage and a differential voltage to a driving circuit.

This application claims the benefit of Taiwan application Serial No. 102100372, filed Jan. 7, 2013, the subject matter of which is incorporated herein by reference.

### BACKGROUND OF THE INVENTION

1. Field of the Invention

The invention relates in general to a dimming circuit and a lighting device using the same, and more particularly to a dimming circuit used for adjusting a light emitting diode (LED) and a lighting device using the same.

2. Description of the Related Art

In the conventional dimming method, an adjustable resistor is serially connected to a circuit for controlling the loading current flowing through the circuit. However, the resistor will consume the power of the circuit and diminishes emission efficiency.

Pulse width modulation (PWM) advantageously has lower noise effect and lower power consumption, and can thus be used for dimming the light of the lighting device. PWM uses non-continuous current for dimming the light. When the current output is not 100%, a part of current is 0 in each output period of PWM. The light device shows a dark state in 0 current region. The dimming can be achieved by adjusting the ratio of dark state to bright state in PWM signal. In general, the PWM signal frequency is higher than 1 kHz and is higher than a frequency range which is invisible to human eyes, and the user will not be aware of flickering of the light.

However, when shooting an image, if the scanning frequency of the camera is lower than the operating frequency of the light dimming PWM signal, a flicker will occur, and the image will have strips or grids to have distortion problem.

Besides, when PWM is set as low-pass, the light might flicker due to insufficient current.

### SUMMARY OF THE INVENTION

The invention is directed to a dimming circuit and a lighting device using the same capable of overcoming the problems of flickering when the light source is in a low-pass state.

According to one embodiment of the present invention, a dimming circuit is provided. The dimming circuit comprises an interface trigger unit, an average duty cycle calculation unit, a control voltage calculation unit and a comparison unit. The interface trigger unit receives an on-time of each pulse width from periods of a PWM signal. The average duty cycle calculation unit is coupled to the interface trigger unit for calculating a ratio of the on-time to the periods, wherein the on-time are outputted from the interface trigger unit. The control voltage calculation unit is coupled to the average duty cycle calculation unit for calculating a desired voltage according to the ratio obtained by the average duty cycle calculation unit. The comparison unit is coupled to the control voltage calculation unit for calculating a differential voltage between the desired voltage and a feedback voltage and sending the desired voltage and the differential voltage to the driving circuit.

According to another embodiment of the present invention, a lighting device is provided. The lighting device comprises an LED, a driving circuit and a dimming circuit. The driving circuit controls the LED to emit a light. The dimming circuit comprises an interface trigger unit, an average duty cycle calculation unit, a control voltage calculation unit and a comparison unit. The interface trigger unit receives an on-time of pulse width from each period of a first PWM signal. The average duty cycle calculation unit is coupled to the interface trigger unit for calculating a ratio of the on-time to the periods, wherein the on-time are outputted from the interface trigger unit. The control voltage calculation unit is coupled to the average duty cycle calculation unit for calculating a desired voltage according to the ratio obtained by the average duty cycle calculation unit. The comparison unit is coupled to the control voltage calculation unit for calculating a differential voltage between the desired voltage and a feedback voltage and sending the desired voltage and the differential voltage to the driving circuit. The driving circuit compensates the control voltage outputted to the LED according to the differential voltage. The control voltage is generated according to a second PWM signal, and the frequency of the second PWM signal is higher than that of the first PWM signal.

The above and other aspects of the invention will become better understood with regard to the following detailed description of the preferred but non-limiting embodiment(s). The following description is made with reference to the accompanying drawings.

### BRIEF DESCRIPTION OF THE DRAWINGS

FIG. 1 shows a functional block diagram of a dimming circuit according to an embodiment of the invention.

FIG. 2A shows a voltage vs. time relationship of a PWM signal having positive waveform.

FIG. 2B shows a schematic diagram of the PWM signal of FIG. 2A having passed through the interface trigger unit of the invention.

### DETAILED DESCRIPTION OF THE INVENTION

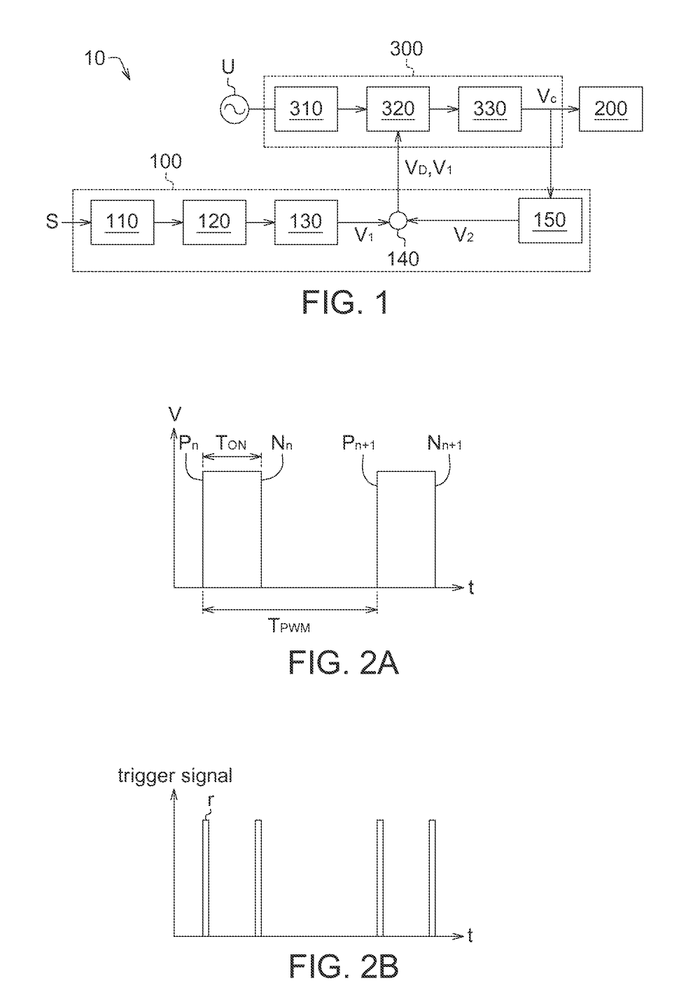

FIG. 1 shows a functional block diagram of a dimming circuit according to an embodiment of the invention. The dimming circuit 100 comprises an interface trigger unit 110, an average duty cycle calculation unit 120, a control voltage calculation unit 130 and a comparison unit 140.

The interface trigger unit 110 receives an external first pulse width modulation (PWM) signal S, and converts the positive edge and the negative edge of the pulse width from the PWM signal into a trigger signal for calculation purpose. Referring to FIG. 2A, a voltage vs. time relationship of a PWM signal having positive waveform is shown. The edge with increasing voltage value is referred as a positive edge, and the edge with decreasing voltage value is referred as a negative edge. A pulse has a positive edge and a negative edge. The PWM signal of FIG. 2A comprises two positive edges Pₙ and Pₙ₊₁ and two negative edges Nₙ and Nₙ₊₁. After the PWM signal passes through the interface trigger unit 110, the PWM signal of FIG. 2A is converted into a trigger signal r of FIG. 2B in which the positions of positive edges and negative edges are recorded.

In this embodiment, the provided PWM signal (FIG. 2A) has positive waveform, therefore the time interval between two adjacent positive edges Pₙ and Pₙ₊₁ defines a period T_{PWM} of the PWM signal, and the time interval between the positive edge Pₙ and the next negative edge Nₙ defines an on-time T_{ON} of the pulse width of the period. When the provided PWM signal has reverse waveform (not illustrated), the time interval between two adjacent negative edges defines a period, and the time interval between a negative edge and the next positive edge defines an on-time.

The average duty cycle calculation unit 120 is coupled to the interface trigger unit for calculating a duty cycle of the first PWM signal S, that is, a ratio of the on-time to the period. The duty cycle is obtained according to the following formula:

$$D = \frac{{T}_{ON}}{{T}_{PWM}}$$

Wherein D represents a duty cycle, T_{ON} represents an on-time, and T_{PWM} represents a period. For example, if the period of a PWM signal is 1 second and the on-time occupies 0.2 second, then the duty cycle is 20%. If the period and the on-time of a PWM signal is a fixed value, then the duty cycle of each pulse is equal to the duty cycle of the entire PWM signal. If the period and the on-time of each pulse of a PWM signal varies, then the average duty cycle calculation unit 120 calculates the duty cycle of each pulse to obtain an average value of the duty cycles .

The control voltage calculation unit 130 is coupled to the average duty cycle calculation unit 120 for calculating a desired voltage V₁ required when the outputted current is a direct current according to the average duty cycle outputted from average duty cycle calculation unit 120 For example, when the voltage of the first PWM signal S is 5V and the average duty cycle is 20%, the desired voltage is equal to 5×20%=1V.

The comparison unit 140 is coupled to the control voltage calculation unit 130 for sending the desired voltage V₁ to the driving circuit of the light source, such as the driving circuit 300 of FIG. 1, for dimming the light.

In an embodiment, the dimming circuit 100 further comprises a feedback unit 150 for compensating energy loss of the circuit. The feedback unit 150 is coupled between the comparison unit 140 and the driving circuit 300 of the light source for converting a current into a feedback voltage V₂ and outputting the feedback voltage V₂ to the comparison unit 140, wherein the current is outputted from the driving circuit to the light source. In this embodiment, the comparison unit 140, after receiving the feedback voltage V₂, calculates a differential voltage V_{D} between the feedback voltage V₂ and the desired voltage V₁, and sends the desired voltage V₁ and the differential voltage V_{D} to the driving circuit 300.

To summarize, the dimming circuit 100 receives frequency from a PWM dimming signal whose frequency ranges from Hz-kHz, and converts the received frequency into a specific desired voltage V₁, and further changes the outputted current into a continuous direct current. The dimming circuit 100 of the invention not only advantageously has low loss of PWM signal but also resolves the problems of light flickering when the light source is in a low-pass state.

In an embodiment, the dimming circuit 100 can be used in the field of illumination. Referring to FIG. 1. The lighting device 10 comprises the said dimming circuit 100, an LED 200 and a driving circuit 300. The driving circuit 300 is coupled to the dimming circuit 100 and LED 200 for receiving a dimming signal (the differential voltage V_{D} and the desired voltage V₁) from the dimming circuit 100 to generate a control voltage V_{C} to drive the LED 200.

In this embodiment, the driving circuit 300 further comprises a rectifier 310, a power stage 320 and a low-pass filter 330.

The rectifier 310 is coupled to an external voltage U. When the external voltage U is an alternating current voltage, the rectifier converts the alternating current voltage into a direct current voltage.

The power stage 320 is coupled between the rectifier 310 and the comparison unit 140 of the dimming circuit 100 for converting the external voltage U into a control voltage V_{C} according to the differential voltage V_{D} and the desired voltage V₁ outputted from the comparison unit 140. In an embodiment, the control voltage V_{c} is generated according to a second PWM signal (not illustrated) of the driving circuit 300. Preferably but not restrictively, the second PWM signal is a high-frequency signal, and the frequency of the second PWM signal is higher than that of the first PWM signal. That is, regardless of the frequency of the first PWM signal, all PWM signals outputted to the power stage 320 are high frequency signals. In an example, the frequency of the second PWM signal is higher than 20 kHz, and the frequency of the first PWM signal is lower than 5 kHz.

The low-pass filter 330 allows low-frequency signals to pass through but diminishes the signals whose frequencies are higher than the cut-off frequency such that the waveform of the control voltage approximates a direct current waveform.

While the invention has been described by way of example and in terms of the preferred embodiment(s), it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A light emitting diode (LED) dimming circuit, comprising:
an interface trigger unit for receiving an on-time of each pulse width from a plurality of periods of a pulse width modulation (PWM) signal;
an average duty cycle calculation unit coupled to the interface trigger unit for calculating a ratio of the on-time e to the periods, wherein the on-time are outputted from the interface trigger unit;
a control voltage calculation unit coupled to the average duty cycle calculation unit for calculating a desired voltage according to the ratio obtained by the average duty cycle calculation unit; and
a comparison unit coupled to the control voltage calculation unit for calculating a differential voltage between the desired voltage and a feedback voltage and sending the desired voltage and the differential voltage to an LED driving circuit.

2. The LED dimming circuit according to claim 1, further comprising:
a feedback unit coupled between the LED driving circuit and the comparison unit for converting a current into the feedback voltage and outputting the feedback voltage to the comparison unit, wherein the current is outputted from the LED driving circuit to an LED.

3. The LED dimming circuit according to claim 1, wherein the interface trigger unit converts the positive edge and the negative edge of each pulse width of the PWM signal into a plurality of trigger signals and calculates the on-time according to the trigger signals.

4. A lighting device free of flickering, comprising:
an LED:
a driving circuit for controlling the LED to emit a light;
a dimming circuit, comprising:
an interface trigger unit for obtaining an on-time of each pulse width from a plurality of periods of a first PWM signal;
an average duty cycle calculation unit coupled to the interface trigger unit for calculating a ratio of the on-time to the periods, wherein the on-time are outputted from the interface trigger unit;
a control voltage calculation unit coupled to the average duty cycle calculation unit for calculating a desired voltage according to the ratio obtained by the average duty cycle calculation unit; and
a comparison unit coupled to the control voltage calculation unit for calculating a differential voltage between the desired voltage and a feedback voltage of the LED and sending the desired voltage and the differential voltage to the driving circuit;
wherein the driving circuit compensates a control voltage outputted to the LED according to the differential voltage, wherein the control voltage is generated according to a second PWM signal, and a frequency of the second PWM signal is higher than that of the first PWM signal.

5. The lighting device free of flickering according to claim 4, wherein the dimming circuit further comprises:
a feedback unit coupled between the driving circuit and the comparison unit for converting a current into the feedback voltage and outputting the feedback voltage to the comparison unit, wherein the current is outputted from the driving circuit to an LED.

6. The lighting device free of flickering according to claim 4, wherein the interface trigger unit converts the positive edge and the negative edge of each pulse width of the first PWM signal into a plurality of trigger signals and calculates the on-time from the trigger signals.

7. The lighting device free of flickering frequency according to claim 4, wherein the frequency of the second PWM signal of the driving circuit is higher than 20 kHz, and the frequency of the first PWM signal is lower than 5 kHz.

8. The lighting device free of flickering according to claim 4, wherein the driving circuit comprises a rectifier for converting the external alternating current voltage into a direct current voltage.

9. The lighting device free of flickering according to claim 8, wherein the driving circuit further comprises a power stage, which converts an external voltage into the control voltage of the LED according to the differential voltage and the desired voltage outputted from the comparison unit.

10. The lighting device free of flickering according to claim 8, wherein the driving circuit further comprises a low-pass filter, which makes the waveform of the control voltage approximate a direct current waveform.
